(19) United States
(12) Patent Application Publication
(10) Pub. No.: US 2025/0173683 A1
(43) Pub. Date: May 29, 2025

(54) MEMBERSHIP MODEL FOR CO-WORKING SPACE

(71) Applicant: Jamie Sterling, Cape Coral, FL (US)

(72) Inventor: Jamie Sterling, Cape Coral, FL (US)

(21) Appl. No.: 18/523,868

(22) Filed: Nov. 29, 2023

(51) Int. Cl. G06Q 10/1093

(52) U.S. Cl. CPC G06Q 10/1095

(57) ABSTRACT

The embodiments herein disclose office spaces, and more particularly all-inclusive co-working space based on a flexible membership model provided to professionals and independent workers such as freelancers, entrepreneurs, students, and others in need of working spaces. The co-working spaces are located in high-traffic retail areas where each of them are designed to have unique and innovative interior, theme, layout, and floor plan that enhances productivity and collaboration. Each of these co-working spaces are furnished with couching and seating areas, open tables, closed offices, cubical, conference rooms, printer station, ‘Plug n Play’ podcast rooms, mail room, Amazon lockers and a coffee area. Members can check in at the reception at any time, scan the membership card or key in the membership number and use the co-working office space furnished with unique and amenities, services, and specialized equipment.

### TECHNICAL FIELD

The present disclosure relates to sharing office spaces and work environment, and more particularly to all-inclusive co-working space based on a membership model. The present disclosure deals with providing professionals, freelancers, and entrepreneurs with a collaborative and inspiring work environment. Thereby fostering creativity, productivity, and networking opportunities in a flexible and innovative workspace.

### BACKGROUND

The post pandemic world pushed almost all the working sectors to opt for ‘Work From Home.’ Even after the pandemic subsided, the organizations still prefer their employees working from home. What was once thought to be a temporary arrangement, has now become a casual work culture. While this is a convenient system for a few, there are employees who would rather prefer to work in a professional environment than from the comfort of home. The reason being, a professional work environment fosters healthy competition, productivity, and creativity among the employees.

Shared spaces in a working environment such as conference rooms, workrooms, and shared office space require careful management to be effectively utilized. In many instances, shared office spaces that are not carefully monitored tend to be over-scheduled and under-utilized. When scheduling mechanisms are in place, users are incited to reserve a maximal amount of time for a shared space. When too many users behave in this manner, the available shared space becomes scarce as its utilization goes down.

Users often reserve shared space with the intention of utilizing the space. However, complications can arise and users can forget and/or miss their reservation and the space can go unused. When this occurs, other users are typically unaware that the space is not in use and are forced to wait or use other resources. What is needed is a mechanism to curb scheduling behavior that negatively affects the shared space utilization.

U.S. patent application Ser. No. 12/233,221 illustrates a solution for improving shared space availability by dynamically responding user utilization behavior of shared space. In the system, automated sensors within a shared space can be used to detect when spaces are in use. Sensors such as motion detectors, infrared sensors, cameras, and the like can correlate space usage to a reservation system. When a space is reserved by a user, the system can verify space occupancy according to the reservation. If the space is unoccupied and the reservation time has not expired, the space can be automatically freed. If the excess time before reservation expiration is more than a threshold value (e.g., fifteen minutes) the system can penalize the user.

Apart from professionals employed by various companies and organizations, there are independent or self-employed workers such as freelancers, entrepreneurs, students, and others who work from their home but often tend to come across situations where they need temporary and cheaper office spaces to get their work done effectively.

Professionals require an office space, which often takes the form of thousands of square feet leased or owned by the worker's employer. Some workers are self-employed or work for small companies may have more difficult time finding an acceptable space to work. These self-employed or small company workers as well as workers for large businesses have turned to coworking arrangements.

The present disclosure provides an opportunity not only to the professionals but also to the independent or self-employed workers such as freelancers, entrepreneurs, students, and others, to work in a collaborative and inspiring co-working space. Work-at-home professionals, freelancers, entrepreneurs, students, etc., if they find themselves in a situation where working from home feels too distractive, disturbing or isolating and do not have their own office space to rely on, they can opt to purchase membership to work from these co-working spaces which provides unique amenities and services like couches and seating areas, different work spaces, open tables, closed offices, cubicles, conference rooms, printing station, ‘Plug n Play’ podcast rooms, mail room, Amazon Lockers and a coffee area, which are not commonly found in other co-working spaces that already exist.

Coworking is a self-directed, collaborative, and flexible work style, often based around a common interest, such as geographic location, shared social values, etc. Coworking typically employs a shared workplace and independent activities among individuals working with the workplace. Unlike a typical office, coworking often allows workers from different organizations to share resources such as conference rooms, break rooms, receptionists, IT professionals, telecommunications resources, etc. Coworking workers are relieved of the effort of finding, renting, outfitting, supplying, and managing their own space.

Coworking arrangements are attractive to work-at-home professionals, independent contractors, independent scientists, and people who travel frequently typically workers who would otherwise end up working in relative isolation (though coworking is in no way limited to such workers). Coworkers can enjoy a social gathering of a group of people who are still working independently, but who may share certain values and who are interested in the synergy that can happen from working with people who value working in the same place alongside each other. Coworking offers a solution to the problem of isolation that many freelancers experience while working at home, while at the same time letting them escape the distractions of home. Moreover, some larger businesses see the value in offering coworking arrangements for some of their employees who can enjoy the same benefits noted above, even if a large number of them represent a majority of other workers sharing a common workspace.

Co-working spaces allow employees from different organizations and even independent workers to work together in a common place, sharing common resources. Hence, when compared to typical offices, co-working spaces helps build networking opportunities which is crucial for career growth of an individual. In addition to this, such inspiring co-working spaces helps the professionals and other independent workers feel a sense of community which in turn enhances creativity and productivity among the employees and other independent workers.

### OBJECTS

The principal object of the present disclosure is to provide a flexible, collaborative, and innovative co-working space for professionals, independent workers like freelancers and entrepreneurs, students, and others who are in need of a working space.

Further object of the present disclosure is to provide a co-working space equipped with unique amenities and services such as couching and seating areas, open tables, closed offices, cubical, conference rooms, printer station, ‘Plug n Play’ podcast rooms, mail room, Amazon lockers and a coffee area.

Further object of the present disclosure is to provide a co-working space based on a membership model for providing easy access to the members and to cater to specific niche or solve specific pain points for the members.

Further object of the present disclosure is to provide companies and other organizations an option of purchasing membership of these co-working office spaces for their remote employees, which is a cheaper alternative to renting an entire office space.

Another object of the present disclosure is to provide a synergistic work environment to the professionals and other independent workers.

Another object of the present disclosure is to provide professionals and other independent workers with a flexible, innovative, inspiring, and collaborative co-working space so as to help foster creativity, productivity, and networking opportunities among them.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the drawings, in which:

FIG. 1 illustrate an environment in which various implementations of the disclosed invention can operate, according to embodiments as disclosed herein.

### DETAILED DESCRIPTION

The example embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

In the following description, for the purposes of explanation, numerous specific details are set forth in order to provide a thorough understanding of implementations of the present technology. It will be apparent, however, to one skilled in the art that implementations of the present technology can be practiced without some of these specific details.

Described in detail below is the concept of all-inclusive co-working space based on a membership model, which provides a collaborative and inspiring work environment to professionals and independent workers like freelancers, entrepreneurs, students, and others.

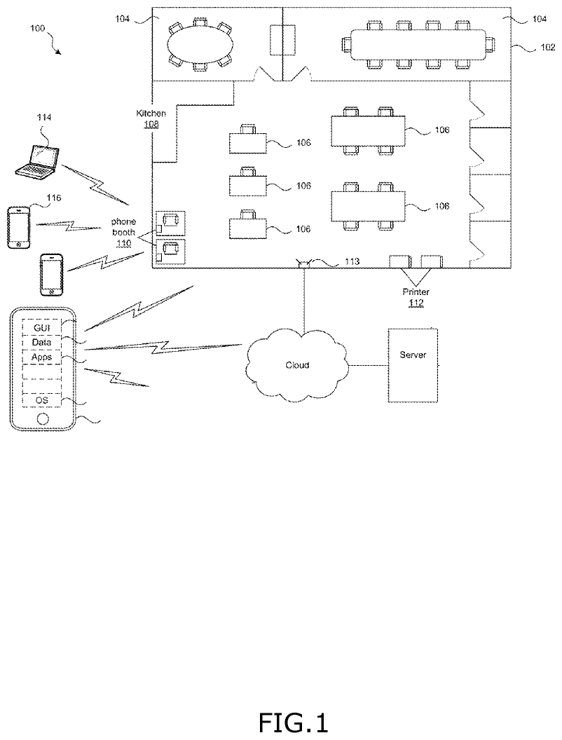

FIG. 1 illustrate an environment in which various implementations of the disclosed invention can operate, according to embodiments as disclosed herein. As illustrated in FIG. 1, the environment 100 includes a co-working facility 102 which may include but not limited to conference rooms 104, desks 106, and a kitchen area 108. The co-working facility 102 may include but not limited to phone booths 110 and a printer station 112, which may also include IT infrastructures such as wireless routers 113 to provide wireless local networking (e.g., IEEE 802.11 Wi-Fi networking), networked or “smart” thermostats, smart lighting, and so forth.

The present disclosure is related to the concept of co-working office spaces that can be used by professionals and independent workers like freelancers, entrepreneurs, students, and others who are in need of office space, by purchasing membership for the same. These co-working office spaces are located in busy/high traffic retail areas and are furnished with unique amenities, services, and specialized equipment such as couching and seating areas, open tables, closed offices, cubical, conference rooms, printer station, ‘Plug n Play’ podcast rooms, mail room, Amazon lockers and a coffee area.

Membership model-Membership will be sold to professionals and independent/self-employed workers who want to work in the co-working office spaces and utilize the multiple resources provided therein. Companies and organizations can also purchase memberships of these co-working office spaces for their remote employees in order to provide them with the resources of a workspace which is a cheaper alternative to renting an entire office space. This concept of membership model for the co-working space is flexible as the membership can be purchase for a day, month, or a year. Members can check in at the reception at any time, scan the membership card or key in the membership number and use the co-working office space furnished with unique and amenities, services, and specialized equipment such as couches and seating areas, open tables, closed offices, cubical, conference rooms, printer station, ‘Plug n Play’ podcast rooms, mail room, Amazon lockers and a coffee area.

As illustrated in FIG. 1, the members using the co-working facility 102 typically have one or more laptop computers 114, mobile phones 116, and other data processing devices that can connect to one or more servers via the wireless routers or via WWAN/cellular base stations and via a network or cloud 120. The server can be coupled to one or more databases. The database stores data such as space data, member data and schedule data. The space data includes data related to physical layout and resources within the co-working facility 102. The member data includes information regarding members who work within the facility 102, and can include information regarding rental or lease data, personal information, preferences, and so forth. The schedule data includes information regarding scheduling of resources within the facility 102, such as the conference rooms 104, desks 106, and so forth.

Each member can access or schedule resources within the facility 102 of the environment 100. As illustrated in FIG. 1, Network or cloud 120 can be any network, ranging from a wired or wireless local area network (LAN), to a wired or wireless wide area network (WAN), to the Internet or some other public or private network. While the connections between the server and the database, these connections can be any kind of local, wide area, wired, or wireless network, public or private.

Design and Layout—The design and layout of each of the co-working office spaces will differ based on the number of square feet but each of them will be designed in such a manner as to have a unique and innovative interior, theme, layout, and floor plan that enhances productivity and collaboration.

Amenities and services—The co-working office spaces will be furnished with unique amenities, services and specialized equipment like couches and seating areas, open tables, closed offices, cubical, conference rooms, printer station, ‘Plug n Play’ podcast rooms, mail room, Amazon lockers, and a coffee area.

As illustrated in FIG. 1, co-worker or a member may require a conference room, cubical or a printer station. As described an application, running on a member mobile device can be configured to allow the member to reserve, book or schedule a space as required by the member. As an example of booking a conference room, the application allows the member to effectively search for a suitable room by viewing and filtering among multiple rooms that provide results matching member's preferences.

The co-working office spaces will have couches and seating areas throughout for the comfort of the members. There will be open tables and cubicles to allow the members to get their work done in their own space. In cases where the members need private spaces to work, they can use the closed offices provided in the co-working space. Further, these co-working spaces are also furnished with conference rooms which the members can use for attending/conducting meetings, for presentations and for any other purposes.

A unique feature about the present disclosure is that the co-working spaces are provided with ‘Plug n Play’ podcast rooms. These podcast rooms are quality recording studios which will be of great help to the members who work as freelancers, entrepreneurs and also to students who are into creating content for social media or other platforms. Given how expensive it is to set up independent podcast studios, it can be said that the present disclosure provides a cheaper and convenient alternative to content creators by providing ‘Plug n Play’ podcast rooms in the co-working space itself.

Further, the co-working spaces are also furnished with printer stations, mail rooms where incoming and outgoing mails can be processed and sorted, Amazon lockers where the members can store their belongings safely and coffee rooms where the members can lounge and relax.

Membership booking and cancellation—As mentioned, the present disclosure is based on a flexible membership model, i.e., members can purchase the membership to use the co-working space and the facilities provided therein either for a day, month, or a year and can come and go any time. This feature may lead to traffic in the usage of facilities such as conference rooms, closed offices and ‘Plug n Play’ podcast rooms. The members will face difficulties in figuring out when a particular facility will be free to use. The current disclosure provides a solution to this particular problem by introducing a system of member booking and cancellation.

This system which is basically a “booking app,” which can be downloaded and logged into on the member's mobile. This app allows the members to view which facility is available at what time and book it in prior. It also lets the member filter out the facilities depending upon their preferences like number of seats they need, availability of audio-visual equipment (AV), temperature of the room, and acoustics for the room (quiet or bright), etc. For example, if a member wants to use the ‘Plug n Play’ podcast room, instead of waiting to get there physically and check whether any of the ‘Plug n Play’ podcast rooms are free to use, members can check on the booking app and book it instantly for a specific period of time so that no other member has access to the ‘plug n Play’ podcast room at the time he/she wants to use it.

In the same manner, if a member wants to use a conference room or a closed office, the booking app will allow the member to effectively search for various conference rooms or closed offices available and the time during which the room is available. It further allows the members to filter out the conference rooms and closed offices available based on their preferences and then book it. The “booking app” also shows the resources available within a particular facility like the number of seats, whiteboards, markers, projectors, etc. This way, there will be no clashes between the members who want to use the same facility at the same time. The “booking app” hence provides a solution for ‘scheduling problems’ that are often faced in the co-working spaces.

Members can book a particular facility for 30 minutes minimum but then can adjust the timeline depending on their need on the “booking app” itself. The members can book a particular facility with a single action or button click, and then there will be a confirmation displayed on the screen providing details of the reserved room, with an option to add that meeting to the member's calendar or to cancel the reservation.

The “booking app” can provide booking confirmation message along with the date and time to the members on requesting to book a room. The member can add the meetings to the calendar, cancel the reservation and invite the guest or edit the reservation. The member can view images of the available rooms along with the timeline identifying available times for the particular room.

Also, the member the user can select a filter for available rooms that meet certain criteria. For example, the user can identify rooms available on a given day, with a given starting time, and for a given duration. Other criteria to filter include number of seats in the room, and amenities available such as whiteboard, phone, TV, etc. Once filters are selected, the member can view rooms meeting the user selected/filtered criteria. Thereafter, the user/member can book the room and then receive a confirmation.

The “booking app” does not only allow booking of the various facilities available but also allows cancellation. Sometimes the members might book a particular facility but then might come across a situation where they do not need to use it at that particular time or day. In such cases the members can cancel their booking so that it will allow others who want to use that particular facility.

In some cases, the members might forget that they have booked a facility at a particular time and not show up to use the same. In such cases, the “booking app” will send a reminder to the member who has booked the app and if in case the member does not give a confirmation regarding the use of the facility for the booked time, it automatically cancels the booking of a particular facility. This allows other members to use the facility if in case it is not occupied at the time it was booked for.

Guest registration-Members who work in the co-working space are also allowed to bring in guests who may be clients or business partners to the co-working space in order to have meetings and presentations. The only requirement to have a permit to bring in guests by the members is that the guests have to be registered before hand both to help keep the facilities secure and to facilitate access for the guests when they arrive at the facility.

Members expect their guests to have seamless and pleasant check-in experience when they arrive at the co-working facility but some of the members may opt out of registering their guests because most of the times such a registration process can be cumbersome, time-consuming, and prone to errors. This will lead to security issues and additional effort of assigning a person to carry out the policing role and hence blurs the focus on relationship building role

To provide a solution for this problem, the present disclosure provides for the registration of guests beforehand on the app so as to avoid the guests from being exposed to a lengthy and confusing check-in process. The member app allows a user to enter a guest's name and email address, as well as providing recent guests from which the user can quickly select to add as guests to register for a new meeting. The member app can pull guest data locally from the user's address book stored on the mobile device or stored remotely

Branding and Community—The present disclosure related to co-working office spaces provides membership to professionals from different companies and organizations and also to independent workers such as freelancers, entrepreneurs, students, and others. Hence, there are people from different backgrounds coming in to utilize the co-working space and the facilities provided therein. This distinct feature of the present disclosure facilitates the growth of sense of community and branding among the members which in turn helps foster productivity, creativity, and networking opportunities in the work environment.

Partnerships—Membership for the co-working office space will be sold not only to individuals but also to the companies and organizations who want to provide an opportunity to their remote working employees to work with resources of a workspace. This helps in building exclusive partnerships with businesses.

1. An all-inclusive co-working office space based on membership model comprising:
a. Couches and seating areas;
b. Open tables;
c. Closed offices;
d. Cubicles;
e. Conference rooms;
f. Printer Station;
g. ‘Plug n Play’ podcast rooms;
h. Mail room;
i. Amazon Lockers;
j. Coffee area;
wherein, receiving an input from a member with a number of attendants, room requirement, meeting time and duration of the meeting;
obtaining meeting room requirements with a size of a meeting room based on the duration of the meeting time and availability of the meeting room;
determining and fetching the meeting room to the member based on the member requirement and duration of the meeting.

2. The all-inclusive co-working office space of claim 1, based on membership model located in high-traffic retail areas where each of them are designed to have unique and innovative interior, theme, layout, and floor plan that enhances productivity and collaboration.

3. The all-inclusive co-working office space of claim 1, comprising plug n play podcast rooms provide a cheaper and convenient alternate to content creators for creating contents for social media or other platforms.

4. The all-inclusive co-working office space of claim 1, provides the member with the filter option based on the preferences with the available resources within a particular facility like the number of seats, whiteboards, markers, projectors.

5. The all-inclusive co-working office space of claim 1, provide scheduling techniques to schedule members with the co-working spaces based on the preferences and availability of the rooms.
